(19) United States
(12) Patent Application Publication
(10) Pub. No.: US 2003/0071181 A1
(43) Pub. Date: Apr. 17, 2003

(54) Multi-purpose display hanger back

(75) Inventors: Stanley C. Valiulis, Rockford, IL (US); Craig Zadak, Roscoe, IL (US)

Correspondence Address: LEYDIG VOIT & MAYER, LTD, 6815 WEAVER ROAD, ROCKFORD, IL, 61114-8018, US

(73) Assignee: Southern Imperial, Inc., Rockford, IL

(21) Appl. No.: 10/025,255

(22) Filed: Dec. 18, 2001

Related U.S. Application Data
(63) Continuation-in-part of application No. 29/149,613, filed on Oct. 12, 2001, now Pat. No. D467792.

(51) Int. Cl. A47K 1/00; E04G 3/00; E04G 5/06; F21V 21/00; A47G 29/00; F21V 35/00; A47B 96/06

(52) U.S. Cl. 248/220.43; 248/220.41; 248/222.51

(57) ABSTRACT

A mounting back is provided for mounting a display hook to a vertical support having spaced apertures. The mounting back generally includes a plate and a pair of prongs. The plate has a front surface constructed to mount the display hook thereto. The pair of prongs are for mounting the back to the vertical support via the apertures. Each prong includes a first portion extending rearwardly from the plate and a second portion extending upwardly from the first portion. Each first portion of the pair of prongs defines a downwardly opening notch therein.

### CROSS-REFERENCE TO RELATED PATENT APPLICATIONS

This patent application is a continuation-in-part of U.S. design patent application No. 29/149,613, filed Oct. 12, 2001.

### FIELD OF THE INVENTION

The present invention relates generally to merchandise display hangers and more particularly relates to mounting backs or brackets for mounting display hooks to apertured vertical supports.

### BACKGROUND OF THE INVENTION

This invention relates to a hanger assembly for supporting articles on a vertical support such as a perforated panel of the type commonly referred to as a “pegboard.” Pegboard comes in many varieties, two primary types being constructed of a wood based particle board (commonly referred to simply as “pegboard”) and sheet metal (commonly referred to as “metal board”). Metal board is typically much thinner than standard pegboard, however both are forms of vertical supports having regularly spaced apertures for supporting various merchandise displays such as display hanger assemblies.

Hanger assemblies for such vertical supports include a hook adapted to project outwardly from the vertical support which is adapted to hold merchandise. An exemplary hanger assembly is disclosed in Bonds, U.S. Pat. No. 4,452,360, in which the hook is adapted to be releasably attached to the panel by a separate mounting back having a pair of horizontally spaced fingers or prongs which extend through the holes in the pegboard. The present invention relates to such assemblies and more specifically relates to a mounting back for such assemblies.

### BRIEF SUMMARY OF THE INVENTION

In one embodiment of the invention, a mounting back is provided for mounting a display hook to a vertical support having spaced apertures. The mounting back generally comprises a plate and a pair of prongs. The plate has a front surface constructed to mount the display hook thereto. The pair of prongs are for mounting the back to the vertical support via the apertures. Each prong includes a first portion extending rearwardly from the plate and a second portion extending upwardly from the first portion. Each first portion of the pair of prongs defines a downwardly opening notch therein.

Preferably, each notch is sized and structured to receive a vertical support of metal board to mount the back to thereto. It is also preferable for the first and second portions of the pair of prongs to be sized and structured to engage a vertical support of pegboard to mount the back thereto. According to more detailed aspects, the plate and pair of prongs are integrally constructed from a unitary sheet of metal. Further, the pair of prongs are connected to the plate adjacent an upper edge of the plate, and are attached to opposing side edges of the plate. In a more detailed version of this embodiment, the front surface of the plate includes two vertically spaced bosses having vertical slots defined therein for receiving the display hook, the vertical slots opening to opposing lateral sides. Additionally, the upper boss further defines an upwardly opening slot connected to the vertical slot defined by the upper boss, the upwardly opening slot and the vertical slot sized to receive the display hook.

According to another embodiment of the invention, a mounting back is provided for mounting a display hook to vertical supports having spaced apertures, the vertical supports having different thicknesses varying from thin supports to thick supports. The mounting back generally comprises a plate having a front surface constructed to mount the display hook thereto, and a pair of prongs for mounting the back to vertical supports via the apertures. Each prong includes a first portion extending rearwardly from the plate and a second portion extending upwardly from the first portion, the first portion defining a downwardly opening notch therein. The pair of prongs engages the vertical support when the back is mounted to thicker vertical supports. The notch receives the vertical support when the back is mounted to thinner vertical supports.

Accordingly, the mounting back may be mounted to thicker vertical supports, such as pegboard, and thinner vertical supports such as metal board. Preferably, the plate includes a tab projecting rearwardly therefrom to position the plate at an angle relative to the vertical support. Typically, the tab is positioned below the pair of prongs. When the plate includes a tab, the second portion of the pair of prongs is preferably rotated relative to the plate such that the second portion is generally parallel to the vertical support when the plate is rotated relative to the vertical support. Similarly, the first portion of the pair of prongs includes a rear wall defined by the notch, the rear wall being rotated relative to the plate such that the rear wall is generally parallel to the vertical support when the plate is rotated relative to the vertical support.

According to yet another embodiment of the invention, a mounting back is provided for mounting a display hook to vertical supports having spaced apertures, the vertical supports having different thicknesses. The mounting back generally comprises a plate having a front surface constructed to mount the display hook thereto, and a pair of prongs for mounting the back to the vertical support via the apertures. Each prong includes a first portion extending rearwardly from the plate and a second portion extending upwardly from the first portion. The pair of prongs and plate define a first pocket and a second pocket, the first and second pockets being of different sizes and structured to receive vertical supports of different thicknesses therein. Preferably, the first pocket is upwardly opening, and is defined by the first and second portions of the pair of prongs and a rear surface of the plate. Also preferable, the second pocket is downwardly opening and is defined by the notch and a rear surface of the plate.

In still another embodiment of the invention, a mounting back is provided for mounting a display hook to vertical supports having spaced apertures, the vertical supports having different thicknesses including a thin support and a thick support. The mounting back generally comprises a plate having a front surface constructed to mount the display hanger thereto. Means are provided for connecting the plate to a thick support. Further, means are provided for connecting the plate to a thin support. Preferably, the thin support is metal board and the thick support is pegboard. According to more detailed aspects of the embodiment, the means for connecting the plate to a thick support includes a pair of prongs extending rearwardly and upwardly from the plate to define a first pocket for receiving the thick support. Additionally, the means for connecting the plate to a thin support includes a pair of prongs extending rearwardly and downwardly from the plate, to define a second pocket for receiving the thin support.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of an embodiment of the mounting back constructed in accordance with the teachings of the present invention;

FIG. 2 is a top view of the mounting back depicted in FIG. 1;

FIG. 3 is a side view, taken from the left, of the mounting back depicted in FIG. 1;

FIG. 4 is a front view of the mounting back depicted in FIG. 1

FIG. 5 is a side view, taken from the right, of the mounting back depicted in FIG.

FIG. 6 is a bottom view of the mounting back depicted in FIG. 1;

FIG. 7 is a front view of the mounting back depicted in FIG. 1, having a display hook mounted thereto to form a hanger assembly, the hanger assembly being mounted to standard pegboard;

FIG. 8 is a front view of the mounting back depicted in FIG. 1, having a display hook mounted thereto to form a hanger assembly, the hanger assembly being mounted to metal board;

FIG. 9 is a side view of the mounting back and hanger assembly depicted in FIG. 7;

FIG. 10 is a side view of the mounting back and hanger assembly depicted in FIG. 8;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The present invention provides a mounting back that is adaptable to different types of vertical supports having spaced apertures, and more particularly, to such vertical supports having different thicknesses. For example, standard pegboard typically has a thickness in the range of 0.200 to 0.250 inches. Meanwhile, metal board can provide the same strength and support with much less material, and typically has a thickness ranging from 0.050 inches to 0.065 inches. Heretofore, it has been known to utilize separate types of mounting brackets to mount display hooks to these various types of apertured vertical supports.

In accordance with the present invention, a single mounting back is provided which can mount display hooks to perforated vertical supports having varying thicknesses. The embodiment being depicted herein is designed to mount to both standard pegboard and metal board, although it will be appreciated that other types of vertical supports are also envisioned and form a part of the present invention. Referring now to the drawings, FIGS. 16 show one embodiment of the mounting back of the present invention. The mounting back 20 generally comprises a plate 30 having a pair of prongs 40 for mounting the back 20 to an apertured vertical support. In the illustrated embodiment, the mounting back 20 is integrally constructed from a unitary sheet of metal which is then stamped, cut, bent, or otherwise manipulated into the desired shape. However, it will be readily understood that the present invention may be employed with separate elements or with other materials such as a sturdy plastic which may be injection molded, or from any other suitable material and corresponding methods as will be readily understood by those having skill in the art.

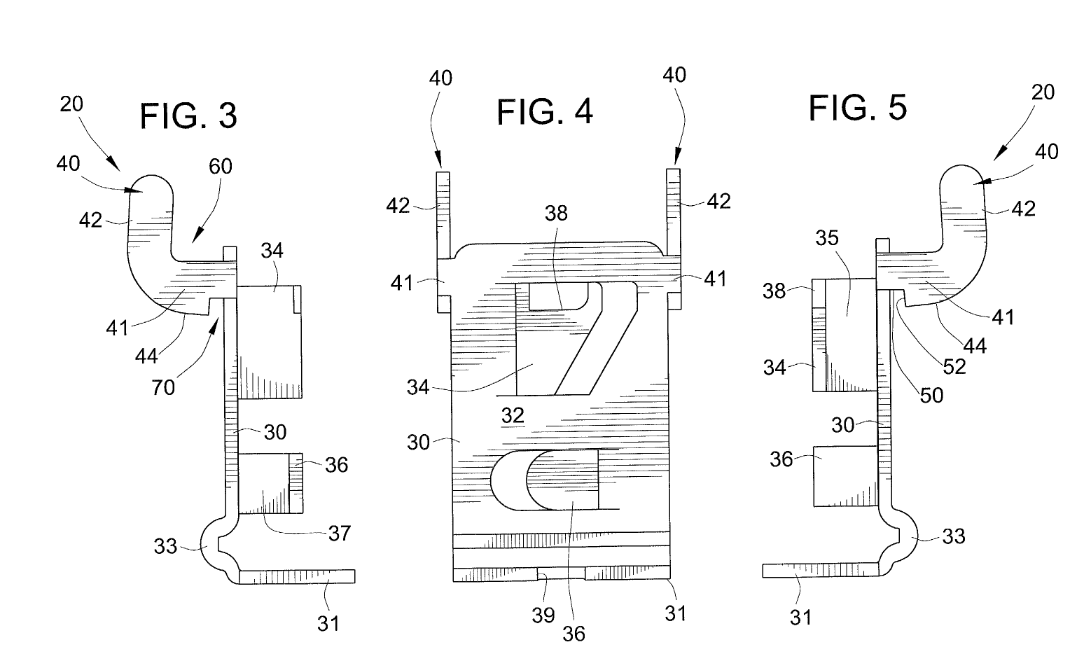

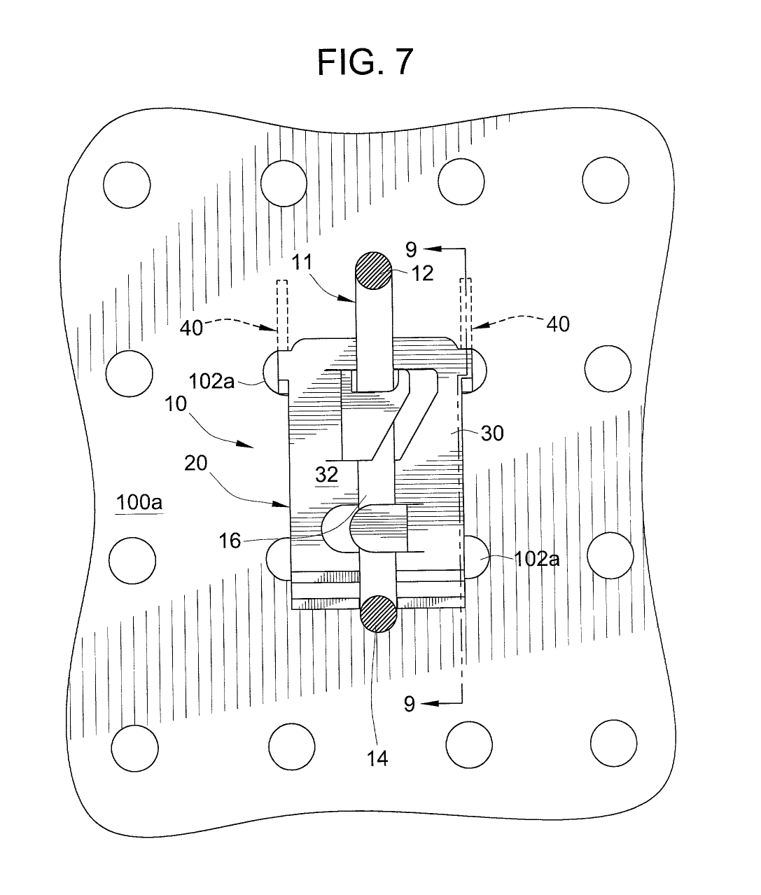

The mounting back 20, and more particularly, the plate 30, has a front face 32 which is adapted to mount a display hook thereto (FIGS. 7-10). That is, the front face 32 includes connection means for connecting a display hook to the bracket 20. In the embodiment illustrated, this connection means comprises two vertically spaced bosses 34, 36, having vertical slots 35, 37 (FIGS. 3,5,6) defined therein for receiving the display hook. The slots 35, 37 are vertically aligned. Preferably, the vertical slots open to opposing lateral sides of the back 20, whereby a display hook, such as a scanning hook having a central connection member linking upper and lower outwardly extending arms, may be placed between the bosses 34, 36, and rotated about a horizontal axis such that the connection member enters the two vertical slots 35, 37. Then, the display hook may be moved downwardly, such that the upper arm engages an upwardly opening slot 38 formed in the upper boss 34, and the connection member extends downwardly through a bottom portion 31 of the plate 30 having a horizontally opening slot 39 defined therein. For further details of such a connection mechanism, see U.S. Pat. No. 4,452,360. It will be recognized that numerous other connection means may be employed by the back 20 of the present invention, including, but not limited to, simple bosses formed on the front face 32 for welding display hooks thereto, single bosses having a vertical slot formed therein for receiving a downturned portion of a display hook, as well as many other structures that are known in the art. Reference is made to the Southern Imperial catalog entitled “Display Hooks and Accessories,” containing information on such structures, which can also be found at http://www.southernimperial.com.

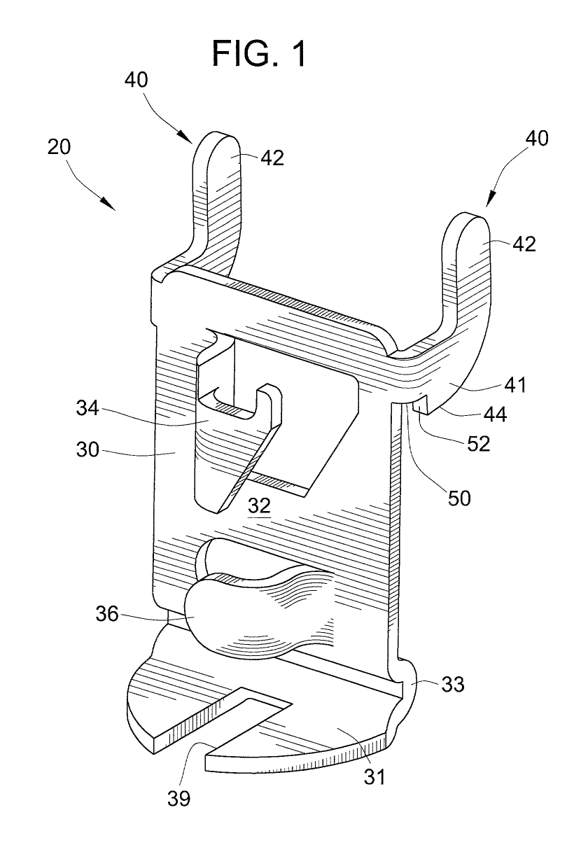

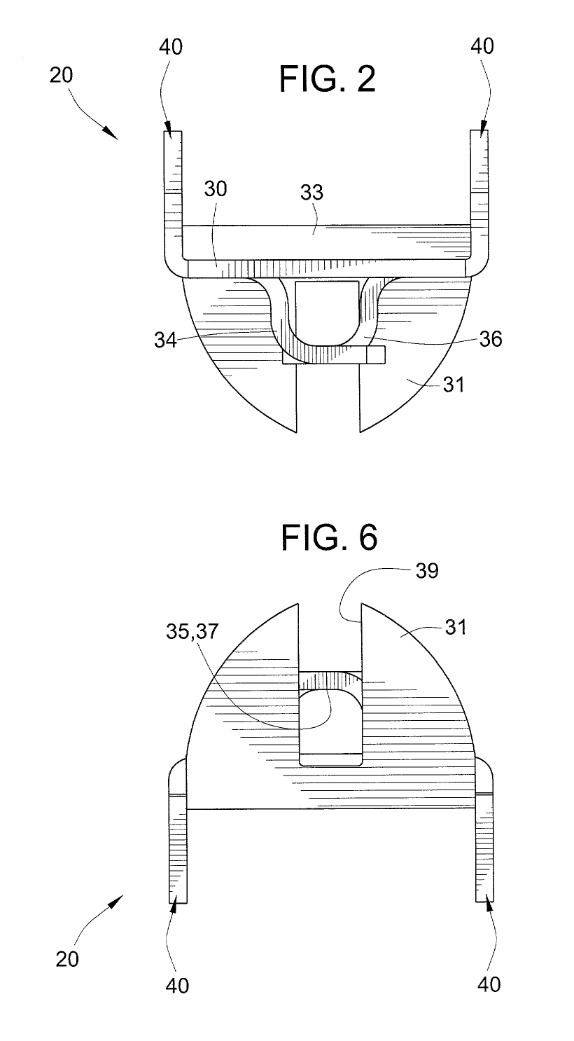

In the embodiment of the back 20 depicted in FIGS. 1-6, the back is constructed to be connected to an apertured vertical support by way of the pair of prongs 40 connected thereto. Each prong generally comprises a first portion 41 extending rearwardly from the plate 30, and a second portion 42 extending upwardly from the first portion 41. Each first portion 41 further includes a notch 50 defined adjacent a lower edge 44 of the first portion 41. The notch 50 is downwardly opening and extends forwardly to the plate 30. In the illustrated embodiment, the notch 50 extends forwardly to the front surface 32 of the plate, since the prongs 40 are first cut from the blank and then bent rearwardly as shown. Preferably, the notch 50 extends a horizontal distance less than a horizontal length of the first portion 41, and more particularly, the length of the upper surface of the first portion 41 before it turns upwardly into the second portion 42.

The pair of prongs 40 are attached to opposing side edges of the plate 30, although they could be attached to any edge or surface of the plate 30. Similarly, the prongs 40 are attached adjacent and upper edge of the plate 30, although they could be placed at any position along the height of the plate. It can be seen that when the back 20 is constructed of sheet metal, a general shape may be cut from the sheet metal, the tab 33 may be formed, and the bottom portion 31 may be bent upwardly relative to the plate 30 to be generally normal thereto. Similarly, the upper and lower bosses, 34 and 36 may be formed from the material of the plate 30 by stamping, cutting and bending. Likewise, the pair of prongs 40 may then be bent rearwardly to be generally normal to the plate 30 to define the first portion 41 extending rearwardly an the second portion 42 extending upwardly.

The plate 30 may further include a rearwardly projecting tab 33 for placing the bracket 20 at a desired viewing angle when placed on a vertical support. The tab 33 is generally positioned below the prongs 40. The tab 33 is preferably stamped into the plate, although other formation methods are contemplated herein as would be readily understood by a person skilled in the art. In order to accommodate this rotation of the bracket 20 and plate 30 relative to the vertical support, the second portion 42 of each prong 40 is rotated slightly relative to the plate 30, or more particularly relative to a vertical plane defined by the plate. It can bee seen in FIGS. 3 and 5 that the second portion 42 is rotated slightly towards the plate 30, preferably at an angle between 1 and 5 degrees, and more preferably rotated 2 to 3 degrees. Similarly, the notch 50 defined in the first portion 41 includes a rear wall 52 which is similarly angled (FIG. 5). Preferably, the rear wall 52 is angled at about 5 degrees. While the tab 33 is preferable, it is not necessary to practice the present invention and the plate 30 may be adapted to lie substantially flush with the vertical supports 100a, 100b. The notch 50 and the prong 40 can be constructed to be generally parallel to the plate 30, to correspond with a table 55 back 20, as will be readily understood by those in the art.

As shown in FIG. 3, the pair of prongs 40 generally define a first pocket 60, defined by the first portion 41, second portion 42, and a rear surface of the plate 30. The pair of prongs 40 further define a second pocket defined by the notch 50 and a rear surface of the plate 30. The first pocket 60 is generally larger than the second pocket 70. Accordingly, the pair of prongs 40 are adapted to receive two different sizes of vertical supports, generally defined by the sizes of the first and second pockets 60, 70. The first pocket 60 is upwardly opening while the second pocket 70 is downwardly opening. While an upper edge of the plate 30 is shown extending above the first portion 41 of the prongs 40, (see FIGS. 3 and 5) it will be understood that the plate 30 may terminate at the first portion 41. Thus it will be seen that the first pocket 60 is simply defined by the first portion 41 and second portion 42 and a vertical plane defined by the plate 30.

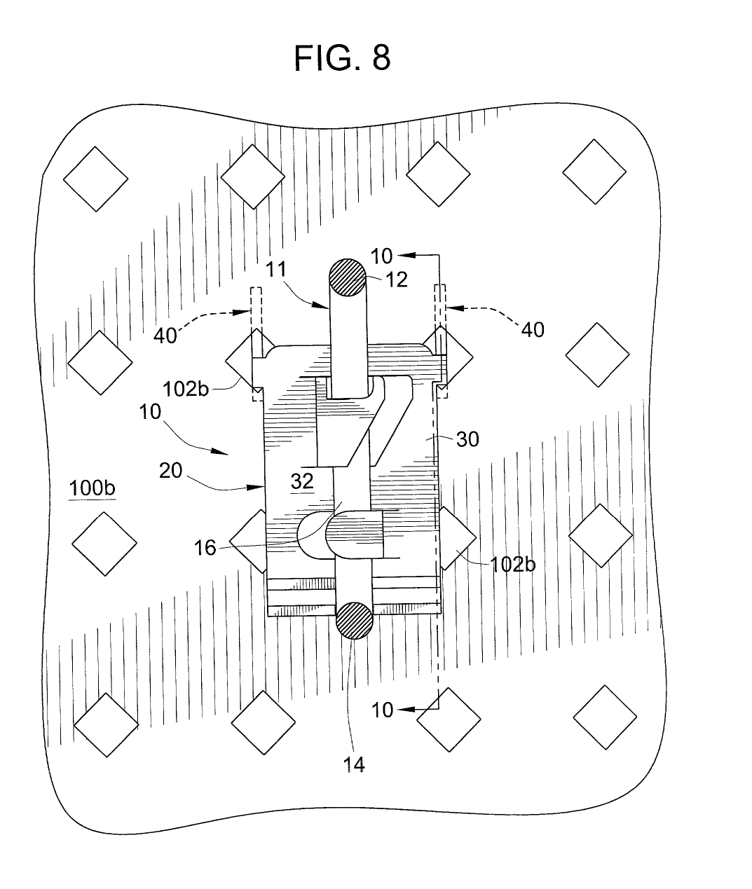

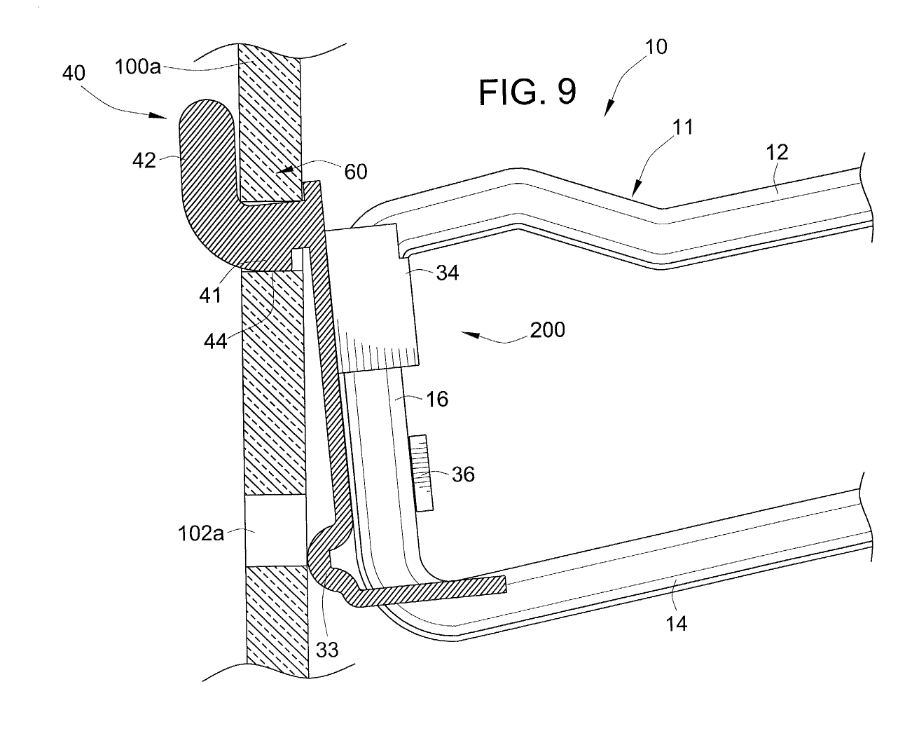

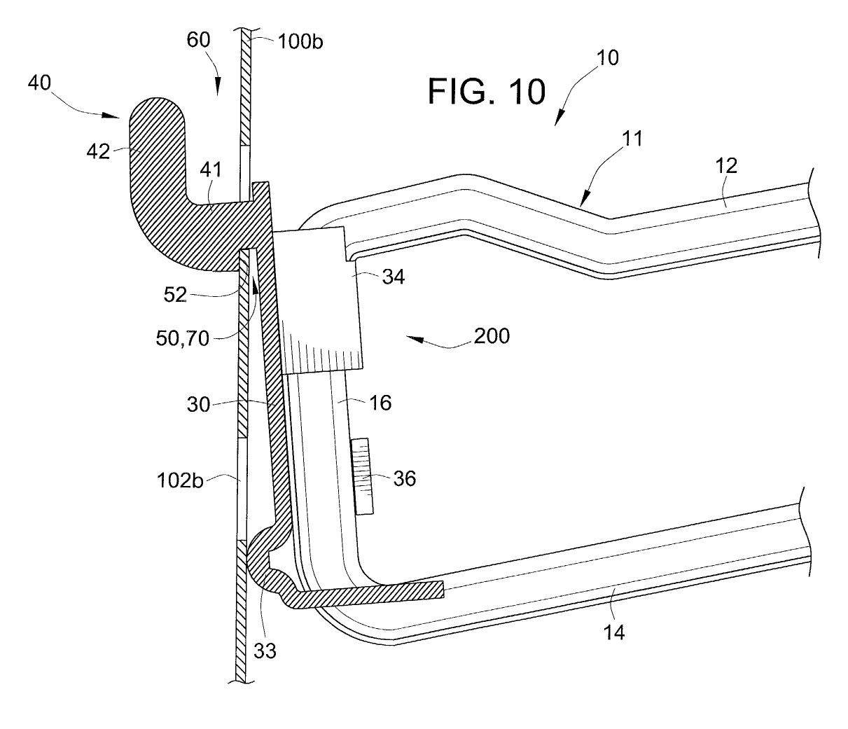

By virtue of the construction of the back 20, one embodiment being shown in FIGS. 1-6, the back 20 may be mounted to vertical supports having varying thicknesses, as will be described with reference to FIGS. 7-10. One example of a thick vertical support is standard pegboard having a typical thickness of 0.200 and 0.250 inches. Metal board is a common thin vertical support and typically has a thickness between 0.050 and 0.065 inches. As used herein, thicker supports are generally greater than 0.125 inches, while thinner supports are generally less than 0.125 inches. FIGS. 7 and 9 show the mounting back 20 connected to a standard pegboard 100a, while FIGS. 8 and 10 depict the mounting back 20 connected to a metal board 100b. More particularly, the mounting back 20 is shown as part of a hanger assembly 10, wherein a scanning hook 11 having upper and lower arms 12, 14 linked by a connection member 16, is connected to the mounting back 20. It can be seen that standard pegboard 100a typically includes round apertures 102a while the metal board typically includes diamond-shaped apertures 102b.

As shown in FIG. 9, when the mounting back 20 is attached to a thicker vertical support 100a, the prongs 40 extend through an aperture 102a. The second portion 42 of each prong 40 extends along a rear surface of the vertical support 100a, while a lower edge 44 of each first portion 41 engages the surface defined by the aperture 102a. It can be seen that the first pocket 60 is sized to receive the thicker vertical support 100a. The rearwardly projecting tab 33 positions the plate 30 at an angle relative to the vertical support 100a, and hence the rotated second portion 42 is adapted to lie generally flush with the rear surface of the vertical support. While FIG. 9 does not depict the second portion 42 being perfectly flush with the pegboard 100a, in practice the holes 102a are not perfectly cut as shown, and the material is malleable such that the peg will be generally flush with the pegboard. As a design choice, it has been found that rotating the second portion 42 about 3° and the rear wall 52 of notch 50 about 5° provides a versatile mounting back 20 that is well suited for the real-life variations in various pegboards.

As indicated above, the same mounting back 20 may be mounted to thinner vertical supports 100b as depicted in FIG. 10. It can be seen that the second pocket 70, generally defined by the notch 50, is sized to receive the thinner vertical support 100b. The notch 50 is downwardly opening and is sized to receive the vertical support 100b adjacent a lower portion of the aperture 102b. The first portion 41 of the prong 40 extends substantially through the aperture 102b, as does the upturned second portion 42. Again, the tab 33 positions the plate 30 at an angle relative to the vertical support 100b and hence the rear wall 52 of the notch 50 is rotated to lie substantially flush with the rear surface of the vertical support 100b. It can be seen that for both thicker and thinner supports, as depicted in FIGS. 9 and 10, the mounting back 20 lies at substantially the same desired viewing angle.

It can therefore be said that the mounting back 20 generally includes means for connecting the back to thicker vertical supports, as well as means for connecting the back 20 to thinner vertical supports. In the illustrated embodiment, this is accomplished by a first pocket 60 and a second pocket 70, the pockets being differently sized to receive vertical supports of different thicknesses. Preferably, the first pocket 60 is upwardly opening while the second pocket 70 is downwardly opening. It will be recognized that the second pocket 70 may be formed by other structures not including a notch 50 formed in the first portion 41 of each peg 40. Rather, each prong 40 could include a third portion extending downwardly from the first portion 41 to define the second pocket 70. Likewise, the pockets 60, 70 could be both upwardly or downwardly opening, or could be laterally opening as well.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A mounting back for mounting a display hook to a vertical support having spaced apertures, the back comprising:
a plate having a front surface constructed to mount the display hook thereto;
a pair of prongs for mounting the back to the vertical support via the apertures, each prong having a first portion extending rearwardly from the plate and a second portion extending upwardly from the first portion; and
the first portion of the pair of prongs each defining a downwardly opening notch therein.

2. The back of claim 1, wherein each notch is sized and structured to receive a vertical support of metal board to mount the back to thereto.

3. The back of claim 1, wherein the first and second portions of the pair of prongs are sized and structured to engage a vertical support of pegboard to mount the back thereto.

4. The back of claim 1, wherein each notch extends forwardly to at least a rear face of the plate.

5. The back of claim 1, wherein each notch has a horizontal length less than a horizontal length of each first portion.

6. The back of claim 1, wherein the plate and pair of prongs are integrally constructed from a unitary sheet of metal.

7. The back of claim 1, wherein the pair of prongs are connected to the plate adjacent an upper edge of the plate.

8. The back of claim 1, wherein the pair of prongs are attached to opposing side edges of the plate.

9. The back of claim 1, wherein the front surface of the plate includes two vertically spaced bosses having vertical slots defined therein for receiving the display hook, the vertical slots opening to opposing lateral sides.

10. The back of claim 9, wherein the upper boss further defines an upwardly opening slot connected to the vertical slot defined by the upper boss, the upwardly opening slot and the vertical slot sized to receive the display hook.

11. A mounting back for mounting a display hook to vertical supports having spaced apertures, the vertical supports having different thicknesses varying from thin supports to thick supports, the back comprising:
a plate having a front surface constructed to mount the display hook thereto;
a pair of prongs for mounting the back to vertical supports via the apertures, each prong having a first portion extending rearwardly from the plate and a second portion extending upwardly from the first portion, the first portion defining a downwardly opening notch therein;
the pair of prongs engaging the vertical support when the back is mounted to thicker vertical supports; and
the notch receiving the vertical support when the back is mounted to thinner vertical supports.

12. The back of claim 11, wherein thicker vertical supports include pegboard.

13. The back of claim 11, wherein the thinner vertical supports include metal board.

14. The back of claim 11, wherein the plate includes a tab projecting rearwardly therefrom to position the plate at an angle relative to the vertical support.

15. The back of claim 14, wherein the tab is positioned below the pair of prongs.

16. The back of claim 14, wherein the second portion of the pair of prongs is rotated relative to the plate such that the second portion is generally parallel to the vertical support when the plate is rotated relative to the vertical support.

17. The back of claim 14, wherein the first portion of the pair of prongs includes a rear wall defined by the notch, the rear wall being rotated relative to the plate such that the rear wall is generally parallel to the vertical support when the plate is rotated relative to the vertical support.

18. A mounting back for mounting a display hook to vertical supports having spaced apertures, the vertical supports having different thicknesses, the back comprising:
a plate having a front surface constructed to mount the display hook thereto;
a pair of prongs for mounting the back to the vertical support via the apertures, each prong having a first portion extending rearwardly from the plate and a second portion extending upwardly from the first portion;
the pair of prongs and plate defining a first pocket and a second pocket, the first and second pockets being of different sizes and structured to receive vertical supports of different thicknesses therein.

19. The back of claim 18, wherein the first pocket is upwardly opening

20. The back of claim 19, wherein the first pocket is defined by the first and second portions of the pair of prongs and a rear surface of the plate.

21. The back of claim 18, wherein the second pocket is downwardly opening.

22. The back of claim 21, wherein the second pocket is defined by the notch and a rear surface of the plate.

23. A mounting back for mounting a display hook to vertical supports having spaced apertures, the vertical supports having different thicknesses including a thin support and a thick support, the back comprising:
a plate having a front surface constructed to mount the display hanger thereto;
means for connecting the plate to a thick support; and
means for connecting the plate to a thin support.

24. The back of claim 23, wherein the thin support is metal board.

25. The back of claim 23, wherein the thick support is pegboard.

26. The back of claim 23, wherein the means for connecting the plate to a thick support includes a pair of prongs extending rearwardly and upwardly from the plate to define a first pocket for receiving the thick support.

27. The back of claim 23, wherein the means for connecting the plate to a thin support includes a pair of prongs extending rearwardly and downwardly from the plate, to define a second pocket for receiving the thin support.
